(19) United States
(12) Patent Application Publication
(10) Pub. No.: US 2013/0148054 A1
(43) Pub. Date: Jun. 13, 2013

(54) LIGHT GUIDE PLATE AS WELL AS BACKLIGHT MODULE AND LIQUID CRYSTAL DISPLAY DEVICE INCLUDING THE SAME

(71) Applicants: Che-Chang Hu, Shenzhen (CN); Kuang-Yao Chang, Shenzhen (CN); Qian Cao, Shenzhen (CN)

(72) Inventors: Che-Chang Hu, Shenzhen (CN); Kuang-Yao Chang, Shenzhen (CN); Qian Cao, Shenzhen (CN)

(21) Appl. No.: 13/496,080

(22) PCT Filed: Dec. 30, 2011
(86) PCT No.: PCT/CN2011/085087

§ 371 Date: Mar. 14, 2012

(30) Foreign Application Priority Data
Dec. 9, 2011 (CN) 201110410004.3

(51) Int. Cl. G02F 1/1335; F21V 8/00

(52) U.S. Cl. 349/62; 362/617

(57) ABSTRACT

A light guide plate as well as a backlight module and a liquid crystal display device which include the light guide plate. The light guide plate comprises a light entrance surface, a light emitting surface connected with the light entrance surface, and a bottom surface disposed oppositely to the light emitting surface. A plurality of V-shaped groove microstructures is disposed on the light entrance surface, a range of a top angle of the V-shaped groove microstructure is from 100 to 130 degrees. Provided technology is easy to be embodied in the industry and a backlight effect with increased uniformity of emitting light is achieved.

### FIELD OF THE INVENTION

The present invention relates to a liquid crystal display device and more particularly to a light guide plate structure of a backlight module.

### BACKGROUND OF THE INVENTION

A liquid crystal display device employs liquid crystals to display images, typically it is composed of a liquid crystal panel, a backlight module, related digital circuits and a power supply. Backlight module can be divided into three types in terms of a position of a lamp: 1) Side lighting structure which a light source is disposed by a lateral side of a light guide plate; 2) Direct lighting structure which light is emitted from a spontaneous light source and is reflected by a reflecting plate to travel upward, and is emitted toward a front after it is diffused evenly by a diffusing plate; 3) Hollow lighting structure which a hot-cathode tube is used as a light source, this structure uses air as a media for light. A light source pointed downward and after its direction is adjusted and reflected by a prism and a reflecting plate, a part of it travels upward to go through a light guide plate and is emitted from its surface, another part of it enters into a cavity again because of total reflection, then is emitted through the light guide plate after being refracted and reflected. A light source pointed upward enters into the light guide plate and is emitted directly, or is emitted after continued refractions and reflections. The light guide plate is a wedge structure.

In LED backlight design, Side lighting structure is mainly used because of the characteristics of slim and low energy consumption. Because of the enhancement of light emitting efficiency and power of LED, designs with small number of LEDs used as light source are definitely the trend for future development. In a design with small number of LEDs as shown in FIG. 1, an LED emitter 21, which emits light to a light entrance surface 11 of a light guide plate 1, is disposed on a light bar 2, wherein the adjacent LED emitter 21 emitting light interfere each other, so that hot spot mura effect can easily occur at a light entrance of a light guide plate. In order to solve this problem, U.S. Pat. No. 7,123,316 discloses a backlight module with a plurality of microstructures disposed on a light entrance surface of a light guide plate to realize an even backlight, the microstructure can be a Fresnel lens, a V-shaped groove or a sinusoid. U.S. Pat. No. 7,093,968 discloses a backlight module, by having a matte surface or a concavo-convex structure disposed on a bottom surface of a light guide plate to realize an even backlight. These structures are not easy to be embodied in the industry and a light emitting uniformity needs to be further enhanced. Therefore, it is necessary to improve the conventional techniques.

### SUMMARY

In order to solve the technical problems mentioned above, the present invention provides a backlight module structure of a liquid crystal display device, which can be easily embodied in the industry for realizing a backlight effect with increased uniformity of back-light.

Technical solutions employed by the present invention to tackle the abovementioned technical problems include: providing a light guide plate which comprises a light entrance surface, a light emitting surface connected with the light entrance surface, and a bottom surface disposed oppositely to the light emitting surface. A plurality of V-shaped groove microstructures is disposed on the light entrance surface, a range of a top angle of the V-shaped groove microstructure is from 100 to 130 degrees. An ideal range for the top angle of the V-shaped groove microstructure is from 115 to 130 degrees. A more deal range for the top angle of the V-shaped groove microstructure is 120±10 degrees. It is the best for the top angle of the V-shaped groove microstructure to be 120 degrees.

The V-shaped groove microstructure is symmetrical, it includes a first inclined surface and a second inclined surface intersecting with each other, the top angle is an included angle between the first inclined surface and the second inclined surface.

Preferably, it is ideal for the V-shaped groove microstructures to be arranged consecutively on the light entrance surface.

Preferably, it is ideal for the V-shaped groove microstructures to be arranged evenly on the light entrance surface.

The technical solutions employed by the present invention to tackle the abovementioned technical problems further include: providing a backlight module which comprises a light bar, and the abovementioned light guide plate disposed by the light bar.

The technical solutions employed by the present invention to tackle the abovementioned technical problems further include: providing a liquid crystal display device which comprises the abovementioned backlight module.

Comparing to the conventional techniques, according to a light guide plate as well as a backlight module and a liquid crystal display device which include the light guide plate of the present invention, by having a plurality of the V-shaped groove microstructures with the top angle from 100 to 130 degrees disposed on the light entrance surface of the light guide plate, industrial implementation can be easily realized and a backlight effect with increased uniformity of emitting light can be achieved as well.

### BRIEF DESCRIPTION OF THE DRAWINGS

FIG. 1 is an illustration of a light guide plate and a light bar in a backlight module of a prior art;

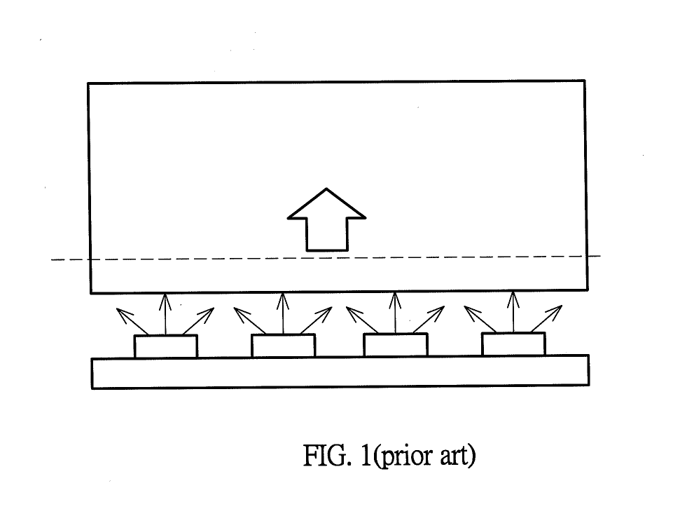

FIG. 2 is an illustration of a light guide plate and a light bar in a backlight module of the present invention;

FIG. 3 is an enlarged illustration of V-shaped groove microstructures disposed on an edge of a light entrance surface of a light guide plate in a backlight module of the present invention;

FIG. 4 is an illustration of light paths at V-shaped groove microstructures disposed on an edge of a light entrance surface of a light guide plate in a backlight module of the present invention;

FIG. 5 is a comparison graph of light transmittance in a light guide plate with a V-shaped groove microstructure with different top angles disposed on an edge of a light entrance surface of the present invention and a light guide plate of an prior art; and

FIG. 6 is an illustration of light transmitting affected by an adjacent V-shaped groove microstructure when a top angle of V-shaped groove microstructures disposed on an edge of a light entrance surface of a light guide plate of the present invention is small.

### DETAILED DESCRIPTION OF THE INVENTION

The present invention will become more fully understood by reference to the following detailed description of a preferred embodiment thereof when read in conjunction with the attached drawings.

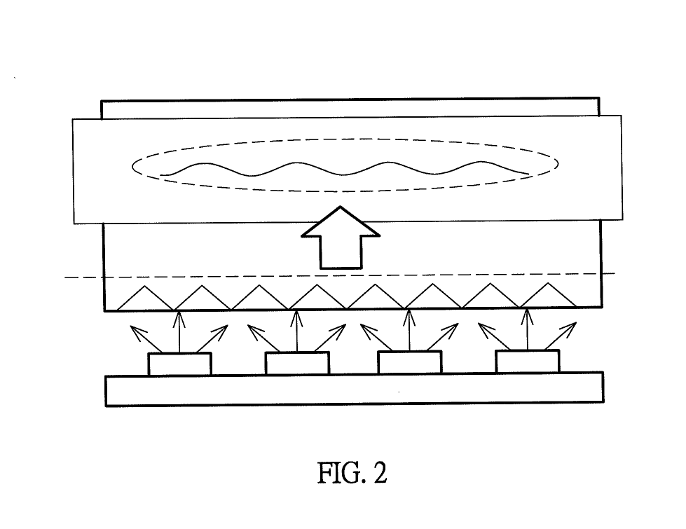

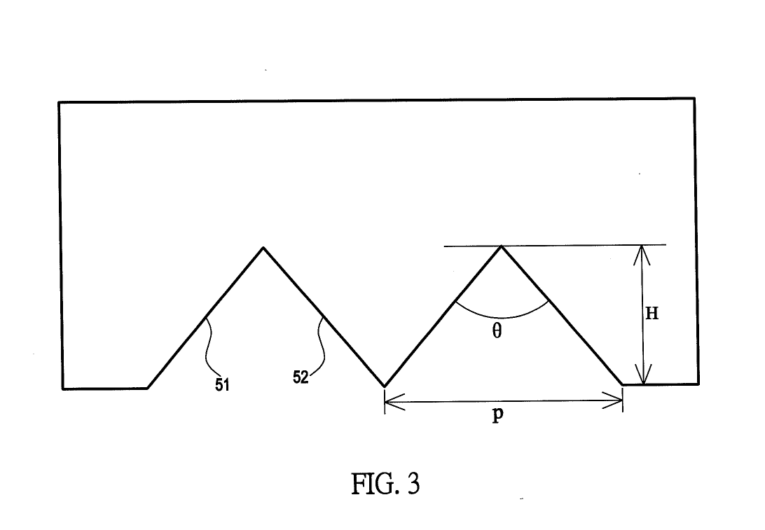

Referring to FIGS. 2 and 3, a light guide plate 1 of the present invention comprises a light entrance surface 11, a light emitting surface connected with the light entrance surface, and a bottom surface disposed oppositely to the light emitting surface. A plurality of V-shaped groove microstructures 12 is disposed on the light entrance surface, a top angle θ of the V-shaped groove microstructure 12 is set within a degree range, when an LED emitter 21 is disposed on a light bar 2 which emits a light to a light entrance surface 11 of a light guide plate 1, the V-shaped groove microstructure 12 affect a direction of the light, which can eliminate the hot spot mura effect effectively.

The V-shaped groove microstructure 12 is symmetrical, in other words, its cross-sectional surface is an isosceles triangular structure, it includes a first inclined surface 121 and a second inclined surface 122 intersecting with each other, a top angle θ of the V-shaped groove microstructure is an included angle between the first inclined surface 121 and the second inclined surface 122, a depth of the V-shaped groove microstructure is a vertical distance H from the light entrance surface to an intersecting point of the first inclined surface 121 and the second inclined surface 122.

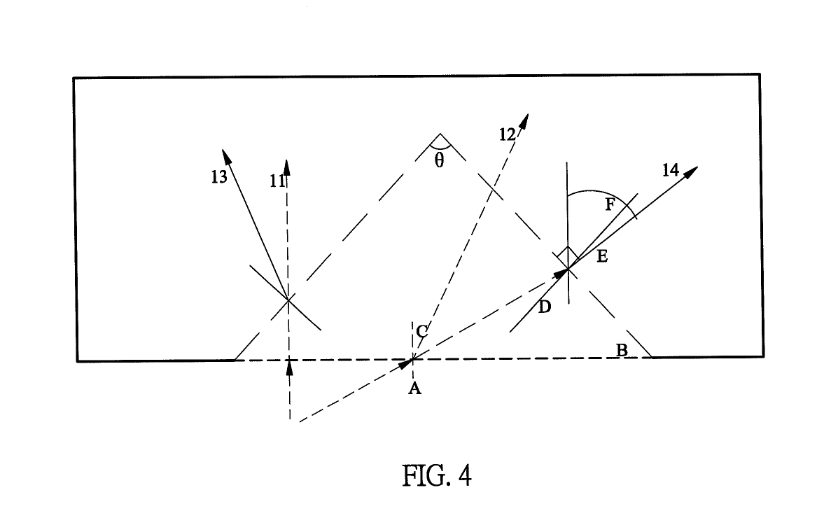

Referring to FIG. 4 for an optical principle of a disposing of the V-shaped groove microstructure, when a light is entered into the ordinary light guide plate from a light source, refractions of the light will occur at an interface because of differences of refractive index as shown by paths indicated by arrows 31 and 32. When a light is entered into the light guide plate 1 with the V-shaped groove microstructures 12 of the present invention from a light source, the light will travel in paths as indicated by arrows 33 and 34. The reason for the different paths is because of the different positions of refractions occurred in the two different light guide plates.

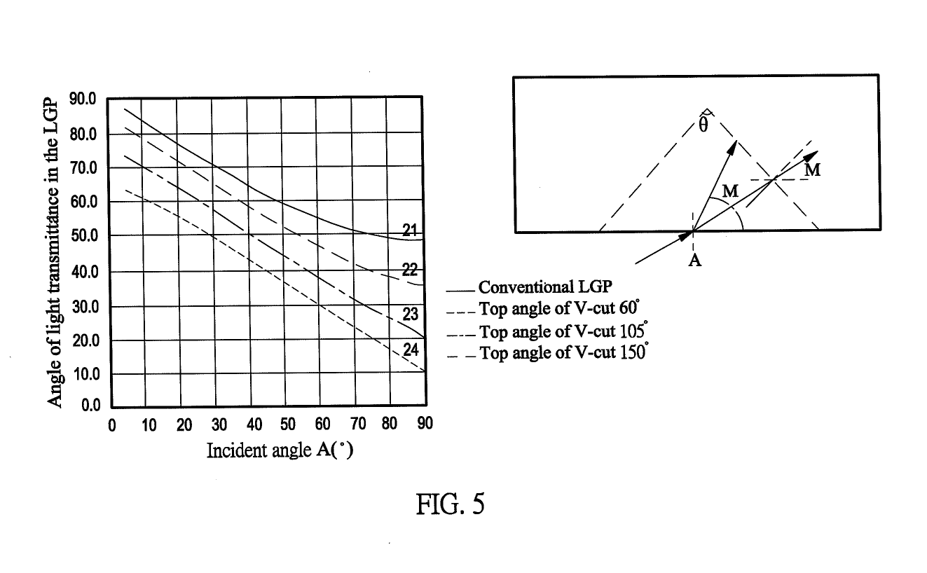

Referring to FIG. 5, it shows a comparison graph of light transmitting in an ordinary light guide plate and a light guide plate with one of the V-shaped groove microstructures disposed on a light entrance surface 11 of a light guide plate 1, wherein a path 41 is a light transmittance in the ordinary light guide plate, a path 42 is a light transmittance in the light guide plate with the V-shaped groove microstructure with a 60 degree top angle, a path 43 is a light transmittance in the light guide plate with the V-shaped groove microstructure with a 105 degree top angle, while a path 44 is a light transmittance in the light guide plate with the V-shaped groove microstructure with a 150 degree top angle.

An incident angle A is an included angle between the light entered into the light entrance surface and a vertical axis of the light entrance surface.

A transmittance angle M is an included angle between the light inside the light guide plate and the light entrance surface.

With only one of the V-shaped groove microstructures 12, the smaller the top angle θ of the V-shaped groove microstructure, the light is transmitted closer to the bottom surface of the light guide plate 1.

Referring to FIGS. 2 and 3, in practical applications, a plurality of the V-shaped groove microstructures 12 is disposed on the light entrance surface 11 of the light guide plate 1, the V-shaped groove microstructures 12 can be arranged consecutively on the light entrance surface 11, in other words, two adjacent V-shaped groove microstructures 12 can be connected to one W-shaped groove microstructure, and without any flat interval. Furthermore, the consecutively arranged V-shaped groove microstructures 12 can be arranged evenly on the light entrance surface 11, in other words, each of the V-shaped groove microstructures 12 are the same with a same top angle and a same depth.

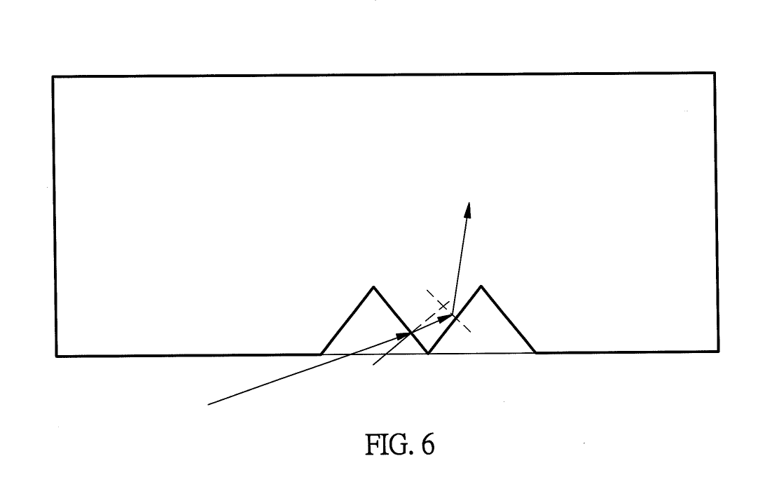

Referring to FIG. 6, the adjacent V-shaped groove microstructures 12 will affect light transmitting, if the top angle θ of the V-shaped groove microstructures 12 is too small, refractions may occur when the light is transmitted between the adjacent V-shaped groove microstructures 12, resulting in further changes in the light paths.

A light guide plate 1 structure of the present invention is performed with simulated tests, with a depth H of within 100 μm which is an applicable manufacturing range of industrial implementation, a relationship between the top angle θ of the V-shaped groove microstructure 12 and a uniformity of illuminance of the light guide plate 1 is shown in the table below:

| The top angle θ of the | |
|---|---|
| V-shaped groove microstructure | uniformity of illuminance |
| 90° | 44.4% |
| 100° | 55.8% |
| 105° | 59.9% |
| 110° | 72.9% |
| 115° | 81.3% |
| 120° | 91.3% |
| 125° | 84.2% |
| 130° | 80.2% |
| — | 37.4% |

It is obvious that, when the top angle θ is 105 degrees, the uniformity of illuminance is closed to 60%, it increases to almost reach 73% when the degrees are increased to 110, in the range of 110 to 130 degrees (boundary values included), the uniformity of illuminance is over 80%, while a peak value of 91.3% is reached with a 120 degrees. In other words, when the top angle of the V-shaped groove microstructure 12 is 120 degrees, the light guide plate features the best uniformity of illuminance.

Considering a convenience of industrial implementation and an acceptability of the uniformity of illuminance, a range of the top angle θ of the V-shaped groove microstructure 12 can be set within 100 to 130 degrees, and it is more ideal for a range of the top angle θ of the V-shaped groove microstructure 12 to be set within 115 to 130 degrees. When processing errors are factored into setting a degree range, 120±10 degree can be set as a machining or processing value of the top angle θ of the V-shaped groove microstructure 12.

Comparing to the conventional techniques, according a light guide plate as well as a backlight module and a liquid crystal display device which include the light guide plate of the present invention, by having the depth H of the V-shaped groove microstructure 12 set within an applicable manufacturing range of industrial implementation, and by having the top angle θ of the V-shaped groove microstructure 12 set within a specific range, industrial implementation can be easily realized and a backlight effect with increased u of emitting light e can be achieved as well.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A light guide plate, comprising :
a light entrance surface, wherein a plurality of V-shaped groove microstructures is disposed on the light entrance surface, a range of a top angle of the V-shaped groove microstructure is from 100 to 130 degrees;
a light emitting surface connected with the light entrance surface; and
a bottom surface disposed oppositely to the light emitting surface.

2. The light guide plate of claim 1, wherein a range of the top angle of the V-shaped groove microstructure is from 115 to 130 degrees.

3. The light guide plate of claim 2, wherein a range of the top angle of the V-shaped groove microstructure is 120±10 degrees.

4. The light guide plate of claim 3, wherein the top angle of the V-shaped groove microstructure is 120 degrees.

5. The light guide plate of claim 1, wherein a depth of the V-shaped groove microstructure is less than 100 μm.

6. The light guide plate of claim 1, wherein the V-shaped groove microstructure is symmetrical, it includes a first inclined surface and a second inclined surface intersecting with each other, the top angle is an included angle between the first inclined surface and the second inclined surface.

7. The light guide plate of claim 1, wherein the V-shaped groove microstructures are arranged consecutively on the light entrance surface.

8. The light guide plate of claim 1, wherein the V-shaped groove microstructures are arranged evenly on the light entrance surface.

9. A backlight module, comprising a light bar, wherein further comprising the light bar is disposed at side of the light guide plate of claim 1.

10. The backlight module of claim 9, wherein a range of the top angle of the V-shaped groove microstructure is from 115 to 130 degrees.

11. The backlight module of claim 10, wherein a range of the top angle of the V-shaped groove microstructure is 120±10 degrees.

12. The backlight module of claim 11, wherein the top angle of the V-shaped groove microstructure is 120 degrees.

13. The backlight module of claim 9, wherein a depth of the V-shaped groove microstructure is less than 100 μm.

14. The backlight module of claim 9, wherein the V-shaped groove microstructure is symmetrical, it includes a first inclined surface and a second inclined surface intersecting with each other, the top angle is an included angle between the first inclined surface and the second inclined surface.

15. The backlight module of claim 9, wherein the V-shaped groove microstructures are arranged consecutively on the light entrance surface.

16. The backlight module of claim 9, wherein the V-shaped groove microstructures are arranged evenly on the light entrance surface.

17. A liquid crystal display device, wherein comprising the backlight module of claim 9.

18. The liquid crystal display device of claim 17, wherein a range of the top angle of the V-shaped groove microstructure is from 115 to 130 degrees.

19. The liquid crystal display device of claim 18, wherein a range of the top angle of the V-shaped groove microstructure is 120±10 degrees.

20. The liquid crystal display device of claim 19, wherein the top angle of the V-shaped groove microstructure is 120 degrees.
